(19) United States
(12) Patent Application Publication
(10) Pub. No.: US 2013/0154573 A1
(43) Pub. Date: Jun. 20, 2013

(54) Method and Apparatus Pertaining to Powering a Movable Barrier Operator Remote Controller

(71) Applicant: James Joseph Fitzgibbon, Batavia, IL (US)

(72) Inventor: James Joseph Fitzgibbon, Batavia, IL (US)

(73) Assignee: THE CHAMBERLAIN GROUP, INC., Elmhurst, IL (US)

(21) Appl. No.: 13/330,851

(22) Filed: Dec. 20, 2011

(51) Int. Cl. F03G 7/08; G08C 19/16

(52) U.S. Cl. 320/137; 320/166; 340/12.1

(57) ABSTRACT

A movable barrier operator remote controller can comprise a vibration-powered electrical generator, a user interface, and a wireless transmitter configured to transmit a movable barrier operator communication in response to the user interface and as powered, at least in part, by the vibration-powered electrical generator. The controller can further comprise an electrical-energy storage unit (such as a battery and/or a capacitor) that is coupled to an electric power output of the vibration-powered electrical generator to thereby receive and store electric power from the vibration-powered electrical generator. So configured, the electrical-energy storage unit can provide operating power to the wireless transmitter on an as-needed basis.

### TECHNICAL FIELD

This invention relates generally to movable barrier operator remote controllers.

### BACKGROUND

Movable barrier operator remote controllers are known in the art. These devices typically serve by responding to a user's input (such as a user's assertion of a button) with a wireless transmission that a corresponding movable barrier operator can compatibly receive. Such a transmission can comprise, for example, a command to move a given movable barrier (such as a garage door, a gate, a rolling shutter, an arm, and so forth). This movement may be, for example, from a closed to an opened position or vice versa. Other commands and communications are also sometimes employed.

A typical movable barrier operator remote controller uses electricity to power such a transmission. Movable barrier operator remote controllers that are portable typically utilize a portable power source such as a battery to supply this electricity. Accordingly, it can become necessary to exchange that battery from time to time for a fresh battery. This, in turn, gives rise to a need for the design of the controller to permit a user to access the battery. Such design considerations, unfortunately, often add cost and/or frailty to the resultant product. Permitting the user to open the controller can also risk exposing delicate circuitry and components to damage that can impair future operability of the controller.

The use of a replaceable battery can also impact the effective range of the controller over time. As the battery discharges the available instantaneous power can deplete as well, leaving less power for the wireless transmitter to use when broadcasting to the movable barrier operator. In such a case, while the controller may still be able to transmit, the maximum operating distance between the controller and the movable barrier operator decreases over time.

### BRIEF DESCRIPTION OF THE DRAWINGS

The above needs are at least partially met through provision of the method and apparatus pertaining to powering a movable barrier operator remote controller described in the following detailed description, particularly when studied in conjunction with the drawings, wherein:

FIG. 1 comprises a flow diagram as configured in accordance with various embodiments of the invention;

FIG. 2 comprises a perspective view as configured in accordance with various embodiments of the invention;

FIG. 3 comprises a block diagram as configured in accordance with various embodiments of the invention; and

FIG. 4 comprises a block diagram as configured in accordance with various embodiments of the invention.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a movable barrier operator remote controller can comprise a vibration-powered electrical generator, a user interface, and a wireless transmitter configured to transmit a movable barrier operator communication in response to the user interface and as powered, at least in part, by the vibration-powered electrical generator. By one approach the vibration-powered electrical generator responds to low vibrational frequencies such as those that typify an ordinary operating motor vehicle such as an automobile.

If desired, the movable barrier operator remote controller can further comprise an electrical-energy storage unit (such as a battery and/or a capacitor) that is coupled to an electric power output of the vibration-powered electrical generator to thereby receive and store electric power from the vibration-powered electrical generator. So configured, the electrical-energy storage unit can provide operating power to the wireless transmitter on an as-needed basis.

These teachings permit provision of a movable barrier operator remote controller having a considerably extended useful life without requiring a change of batteries. Depending upon the requirements of the application setting these teachings may also permit the movable barrier operator remote controller to be smaller in size. These teachings will also permit, if desired, the movable barrier operator remote controller to comprise a sealed unit having a simplified design and components. This, in turn, can lead to reduced cost and/or increased reliability.

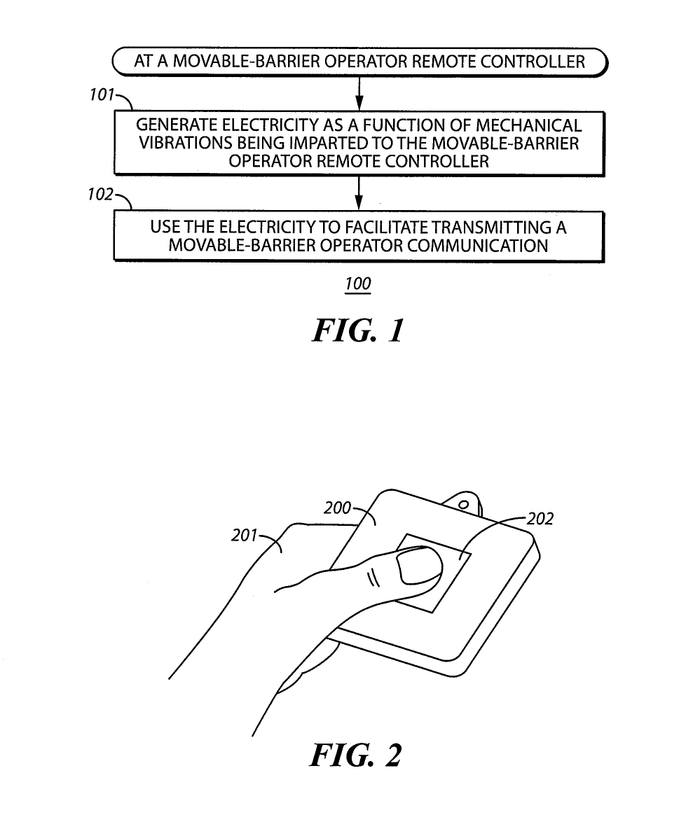

These and other benefits may become clearer upon making a thorough review and study of the following detailed description. Referring now to the drawings, and in particular to FIG. 1, an illustrative process 100 that is compatible with many of these teachings will now be presented.

By one approach a movable barrier operator remote controller carries out this process 100. Referring momentarily to FIG. 2, such a movable barrier operator remote controller 200 can comprise a portable, self-contained apparatus that can be readily grasped by a user's hand 201 and appropriately manipulated during use. This manipulation can include asserting, for example, a user interface 202 such as a button that momentarily closes (or opens) an electrical connection when asserted. Other form factors are of course possible. Examples in these regards include other handheld form factors as well as apparatuses designed to be mounted (for example, by use of one or more clips) to a vehicle's sun visor. As yet another example in these regards, the movable barrier operator remote controller 200 can be disposed within (and hence housed by) a vehicular sun visor. These and other form factors for movable barrier operator remote controllers are known in the art and require no further elaboration here.

Referring again to FIG. 1, at step 101 this process 100 provides for generating electricity as a function of mechanical vibrations being imparted to the movable barrier operator remote controller 200. Further details in these regards are provided below. At step 102, this process 100 then provides for using this generated electricity to facilitate transmitting a movable barrier operator communication. As will also be discussed below, this can comprise making a direct (i.e., immediate) use of generated electricity and/or storing generated electricity and drawing upon that stored electricity at times of need.

The movable barrier operator communication can vary with the needs and/or opportunities as tend to characterize a given application setting. The transmission itself can comprise, for example, a radio-frequency transmission using one or more carriers of choice and/or optical-wavelength transmissions (using, for example, infrared carrier frequencies) as desired. The communication can substantively comprise any of a variety of instructions, status updates/responses, and so forth as desired. Generally speaking, the carrier frequency(ies), modulation, and signaling protocol employed when transmitting the communication will vary with respect to the expectations and requirements of the movable barrier operator itself. Details in these regards are well understood in the art and require no further elaboration here.

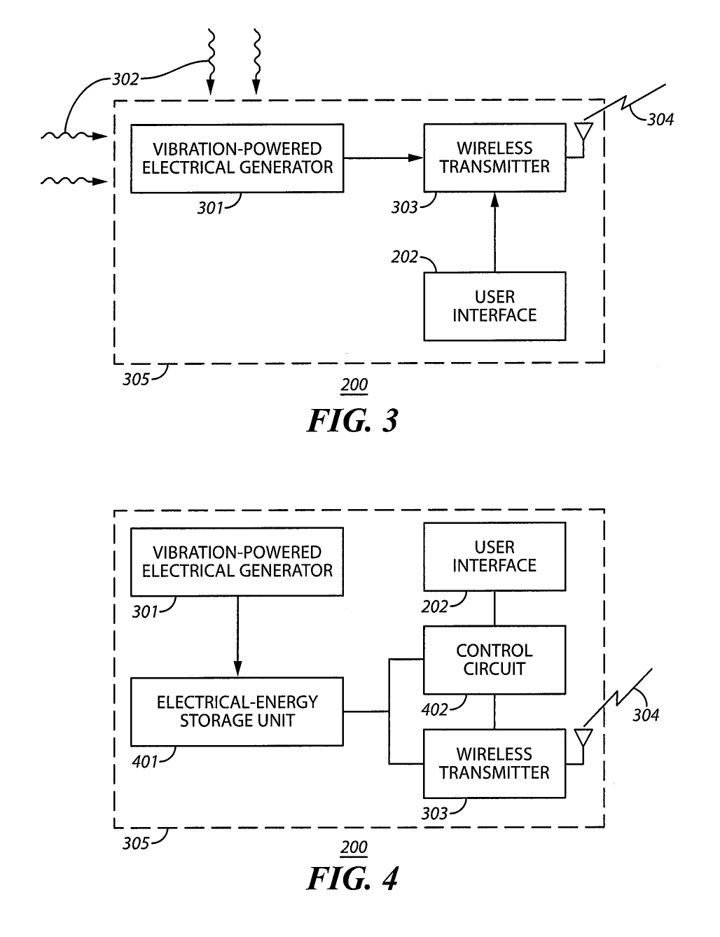

FIG. 3 provides an illustrative example in these regards. In this example the movable barrier operator remote controller 200 includes a vibration-powered electrical generator 301 that responds to vibrations 302 imposed on the movable barrier operator remote controller 200 by generating electricity. A wireless transmitter 303 powered by electricity provided by the vibration-powered electrical generator 301 is configured, in this example, to respond to a user interface 202 by transmitting a wireless movable barrier operator communication 304.

By one approach, the vibrations 302 are low vibrational frequencies (for example, less than, say, 60 Hertz). This might comprise, for example, making use of low vibrational frequencies that are less than 40 Hertz or even less than 10 Hertz. Generally speaking, such frequencies are often evident within the vibrational frequencies of an operating motor vehicle (such as an automobile, a truck, or the like). That is to say, the operating components of the vehicle (such as the engine) as well as external influences acting on the vehicle during operation (including, for example, bumps and the like as the vehicle travels over uneven road surfaces) give rise to a variety of low-frequency vibrations having a variety of durations and amplitudes.

Accordingly, a movable barrier operator remote controller 200 located within an operating vehicle (for example, as clipped to a sun visor, stored in a console or a glove compartment, or placed on a dashboard or other interior vehicular surface) will be well exposed to, and experience, such vibrations. This, in turn, helps to ensure that the vibration-powered electrical generator 301 is suitably located to scavenge the energy of such vibrations.

By one approach, the vibration-powered electrical generator 301 can comprise an apparatus as described in U.S. Pat. No. 7,579,757, entitled METHOD AND MICRO POWER GENERATOR FOR GENERATING ELECTRICAL POWER FROM LOW FREQUENCY VIBRATIONAL ENERGY (the entire contents of which are hereby incorporated herein by this reference). Such an apparatus is configured to mechanically up-convert low-frequency mechanical vibrations to higher-frequency mechanical vibrations that are, in turn, particularly useful for electricity-generating purposes. In any event, such a generator is well suited for the purposes and in-vehicle operating environment described herein.

FIG. 3 also illustrates that the movable barrier operator remote controller 200 can further include a housing 305 that at least substantially encloses and/or otherwise supports the aforementioned components such as the vibration-powered electrical generator 301 and the wireless transmitter 303. As noted above, such a housing 305 can assume any of a wide variety of form factors including, but not limited to, a hand-held, portable device or a vehicular sun visor.

By one approach, if desired, this housing 305 can comprise a sealed housing; i.e., a housing that cannot be non-destructively opened. Such a housing could employ, for example, housing halves that are joined using ultrasonic welding or another permanent affixment approach. This, in turn, avoids a need for screws, snaps, or other non-permanent attachment paradigm that would otherwise be necessary to permit the user to non-destructively access and change a battery as needed.

Viewed literally, FIG. 3 illustrates that the wireless transmitter 303 could be powered by electricity being provided in real time by the vibration-powered electrical generator 301. If desired, however, these teachings will accommodate storing generated electricity to permit a non-real-time usage of generated electricity by the wireless transmitter 303.

FIG. 4 provides an illustrative example in such regards. In this example the electric power output of the vibration-powered electrical generator 301 feeds an electrical-energy storage unit 401. This electrical-energy storage unit 401 can comprise, for example, one or more rechargeable cells/batteries and/or capacitors that are configured to receive and store electric power generated by the vibration-powered electrical generator 301. This electrical-energy storage unit 401 can include other components, such as voltage regulators and charging circuitry, as may be desired to support the specific needs of a particular application setting.

In such a case, the electrical-energy storage unit 401 can operably couple to other components of the movable barrier operator remote controller 200 such as the wireless transmitter 303 and a control circuit 402 that may, in turn, be coupled and configured to control the operation of the wireless transmitter 303 (by configuring and forming, for example, the contents/payload of the aforementioned movable barrier operator communication 304).

So configured, a movable barrier operator remote controller 200 can avoid the design and operating issues that arise when employing batteries that eventually deplete and must be replaced. This can lead to greater user satisfaction as well as improved reliability. Such an approach can also comprise a more ecologically-friendly approach that avoids the need to dispose, over time, a plurality of depleted batteries.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

I claim:

1. A movable barrier operator remote controller comprising:
a vibration-powered electrical generator having an electric power output;
a user interface;
a wireless transmitter configured to transmit a movable barrier operator communication in response to the user interface and as powered, at least in part, by the vibration-powered electrical generator.

2. The movable barrier operator remote controller of claim 1 wherein the vibration-powered electrical generator is configured to respond to low vibrational frequencies.

3. The movable barrier operator remote controller of claim 2 wherein the low vibrational frequencies are within the vibrational frequencies of an operating motor vehicle.

4. The movable barrier operator remote controller of claim 2 wherein the low vibrational frequencies are less than 40 Hertz.

5. The movable barrier operator remote controller of claim 4 wherein the low vibrational frequencies are less than 10 Hertz.

6. The movable barrier operator remote controller of claim 1 wherein the user interface comprises, at least in part, a first button.

7. The movable barrier operator remote controller of claim 1 further comprising:
an electrical-energy storage unit that is coupled to the electric power output of the vibration-powered electrical generator to receive and store electric power from the vibration-powered electrical generator.

8. The movable barrier operator remote controller of claim 7 wherein the electrical-energy storage unit is coupled to the wireless transmitter such that the vibration-powered electrical generator powers the wireless transmitter via the electrical-energy storage unit.

9. The movable barrier operator remote controller of claim 8 wherein the electrical-energy storage unit comprises, at least in part, a battery.

10. The movable barrier operator remote controller of claim 8 wherein the electrical-energy storage unit comprises, at least in part, a capacitor.

11. The movable barrier operator remote controller of claim 1 further comprising:
a housing that at least substantially contains the vibration-powered electrical generator and the wireless transmitter.

12. The movable barrier operator remote controller of claim 11 wherein the housing comprises a portable, hand-held container.

13. The movable barrier operator remote controller of claim 11 wherein the housing comprises a vehicular sun visor.

14. The movable barrier operator remote controller of claim 11 wherein the housing is sealed and cannot be non-destructively opened.

15. The movable barrier operator remote controller of claim 1 wherein the vibration-powered electrical generator is configured to mechanically up-convert low-frequency vibrations to higher-frequency vibrations.

16. A method comprising:
at a movable barrier operator remote controller:
generating electricity as a function of mechanical vibrations being imparted to the movable barrier operator remote controller;
using the electricity to facilitate transmitting a movable barrier operator communication.

17. The method of claim 16 wherein the mechanical vibrations have low vibrational frequencies.

18. The method of claim 17 wherein the low vibrational frequencies are within the vibrational frequencies of an operating motor vehicle.

19. The method of claim 17 wherein the low vibrational frequencies are less than 40 Hertz.

20. The method of claim 17 wherein the low vibrational frequencies are less than 10 Hertz.

21. The method of claim 16 wherein generating electricity as a function of mechanical vibrations comprises, at least in part, mechanically up-converting the mechanical vibrations to higher-frequency mechanical vibrations.

22. The method of claim 16 wherein using the electricity to facilitate transmitting a movable barrier operator communication comprises, at least in part:
storing at least some of the electricity to provide stored electricity;
using the stored electricity to power a wireless transmitter.

23. The method of claim 22 wherein storing at least some of the electricity comprises storing at least some of the electricity in a battery.

24. The method of claim 22 wherein storing at least some of the electricity comprises storing at least some of the electricity in a capacitor.
